(19) United States
(12) Patent Application Publication
(10) Pub. No.: US 2010/0225815 A1
(43) Pub. Date: Sep. 9, 2010

(54) Systems methods and apparatuses for rendering user customizable multimedia signals on a display device

(76) Inventor: Vishal Vincent Khatri, Falls Church, VA (US)

Correspondence Address: Vishal Vincent Khatri, 11001 Blue Roan Road, Oakton, VA, 22124, US

(21) Appl. No.: 12/659,186

(22) Filed: Feb. 26, 2010

Related U.S. Application Data
(60) Provisional application No. 61/202,497, filed on Mar. 5, 2009.

(51) Int. Cl. H04N 5/50; H04N 7/173; H04N 9/74

(52) U.S. Cl. 348/569; 348/731; 725/109; 348/584; 348/E09.055; 348/E05.097

(57) ABSTRACT

A receiver comprising a tuner for receiving a first piece of content and a processor configured to receive the first piece of content from the tuner and a second piece of content. The processor is further configured to combine the first piece of content with a portion of the second piece of content to create a combined piece of content, and to output the combined piece of content to a display device. In exemplary embodiments, the first and second pieces of content are selected by a user.

### CROSS REFERENCE TO RELATED APPLICATIONS

The present disclosure claims the benefit of U.S. Provisional Application No. 61/202,497, filed on Mar. 5, 2009. The contents of this application are herein incorporated by reference in its entirety.

### BACKGROUND OF THE DISCLOSURE

1. Field of the Disclosure

The present disclosure relates generally to systems, methods and apparatuses for rendering user customizable multimedia signals on a display device and more particularly to systems, methods and apparatuses for rendering multiple pieces of user selected content on a display device.

2. Description of Related Art

The television has become one of the most influential forces of our time. With a television, viewers are able to receive information such as news, sports, entertainment, information and commercials in ways that were not possible before.

In general, television content providers assemble and provide television signals to subscribers. These signals are transmitted to subscribers through a cable or over the air. The transmitted signals are received by a receiver associated with the television and processed to recover the information associated with one of the television stations. The selected signal is displayed on the television, generally with associated audio.

The number of television channels for viewers to select from has increased significantly over the years. Although, some of these channels are freely available, most require a paid subscription. Accordingly, most subscribers pay providers for subscriptions that include several hundred television channels. These providers include cable providers and satellite providers. Regardless of the type of provider, television signals have become more advanced as they shift from analog broadcast signals to high definition digital signals.

In addition, the size of the television has increased significantly over the years. It is not uncommon for subscribers to have televisions in their homes that exceed 50 inches. As the available content improves and televisions become larger, the television becomes more integral in daily life. Families rely on having multiple televisions to satisfy the needs of the various family members and with the volume of available channels, subscribers often become frustrated when searching for a desired program.

As a result of these problems, more and more subscribers are turning away from the television and looking to their computer for the desired information. These subscribers have found that the flexibility and speed of their computers outweighs the benefits of their television.

In view of all of these developments and problems, the present inventor has observed that it would be beneficial to provide a television system that is more flexible and customizable by the subscriber in a manner that allows the subscriber to obtain the desired information quickly while making more effective use of larger televisions.

### BRIEF SUMMARY OF THE DISCLOSURE

It is an object of exemplary embodiments of the inventions disclosed herein to provide a television system that is more flexible and customizable by the subscriber in a manner that allows the subscriber to obtain the desired information quickly while also making more effective use of larger televisions.

Exemplary embodiments may provide a receiver that comprises a tuner for receiving a first piece of content; and a processor. The processor may be configured to receive the first piece of content from the tuner and a second piece of content, combine the first piece of content with at least a portion of the second piece of content to create a combined piece of content, and output the combined piece of content to a display device.

In exemplary embodiments, the first and second pieces of content may be selected by a user.

In exemplary embodiments, at least one of the first piece of content and the second piece of content may be received from a television service provider, or similar entity.

In exemplary embodiments, the first piece of content and the second piece of content may both be received from a television service provider.

In exemplary embodiments, the combined piece of content may include less than the entirety of the second piece of content.

In exemplary embodiments, at least one of the first piece of content and the second piece of content may be received from the internet.

In exemplary embodiments, the receiver may also include a storage device for storing user selected parameters for combining the first piece of content with the portion of the second piece of content to create the combined piece of content.

In exemplary embodiments, the receiver may also include a storage device for storing at least one of the first piece of content and the second piece of content.

In exemplary embodiments, the first piece of content may be stored in the storage device to time shift the content and be combined with the second piece of content which is not time shifted.

In exemplary embodiments, a plurality of combined pieces of content can be defined and one of the plurality of combined pieces of content may be displayed based on a determination of a particular event.

In exemplary embodiments, the first piece of content and the second piece of content may be combined such that the first piece of content is substantially unaltered and at least a portion of the second piece of content is displayed over the first piece of content. In exemplary embodiments, the at least a portion of the second piece of content may be configured to be displayed as a banner over the first piece of content (or adjacent the first piece of content).

In exemplary embodiments, the receiver may be configured to allow the user to select audio associated with any of the first piece of content and the second piece of content.

In exemplary embodiments, the receiver may be configured to allow the user to change a selected piece of content without having to reconfigure the receiver.

In exemplary embodiments, the receiver may be configured to allow the user to select one of the first piece of content and the second piece of content and maximize it to occupy the display.

Exemplary embodiments may provide a method for creating a customized piece of content. The method may comprise receiving a first piece of content and a second piece of content, combining the first piece of content with a portion of the second piece of content to create a combined piece of content, and outputting the combined piece of content to a display device.

In exemplary embodiments, the first and second pieces of content may be selected by a user.

In exemplary embodiments, at least one of the first piece of content and the second piece of content may be received from a television service provider, or similar entity.

In exemplary embodiments, the first piece of content and the second piece of content may both be received from a television service provider.

In exemplary embodiments, the combined piece of content may include less than the entirety of the second piece of content.

In exemplary embodiments, at least one of the first piece of content and the second piece of content may be received from the internet.

In exemplary embodiments, the method may also include a storing user selected parameters for combining the first piece of content with the portion of the second piece of content to create the combined piece of content.

In exemplary embodiments, the method may also include storing at least one of the first piece of content and the second piece of content.

In exemplary embodiments, the first piece of content may be stored to time shift the content and be combined with the second piece of content which is not time shifted.

In exemplary embodiments, a plurality of combined pieces of content can be defined and one of the plurality of combined pieces of content may be displayed based on a determination of a particular event.

In exemplary embodiments, the first piece of content and the second piece of content may be combined such that the first piece of content is substantially unaltered and at least a portion of the second piece of content is displayed over the first piece of content. In exemplary embodiments, the at least a portion of the second piece of content may be configured to be displayed as a banner over the first piece of content (or adjacent the first piece of content).

In exemplary embodiments, the method may allow the user to select audio associated with any of the first piece of content and the second piece of content.

In exemplary embodiments, the method may allow the user to change a selected piece of content without having to reconfigure the receiver.

In exemplary embodiments, the method may allow the user to select one of the first piece of content and the second piece of content and maximize it to occupy the display.

Exemplary embodiments may also provide for a system that comprises a computer readable storage medium for storing therein a plurality of pieces of content; and a processor associated with the computer readable medium for receiving a request for one of the plurality of pieces of content and for transmitting the selected content to a receiver associated with a display system. Each of the plurality of pieces of content may be configured to be combined as a banner with a piece of content from a television service provider for display on a display device.

### BRIEF DESCRIPTION OF THE DRAWINGS

Additional objects, features, and advantages of the present invention will become apparent from the following detailed description of embodiments of the invention in conjunction with the accompanying drawings where like reference numerals indicate like features, in which:

FIG. 1 is a schematic representation of an exemplary system in accordance with an exemplary embodiment of the inventions disclosed herein;

FIG. 2 is a schematic representation of an exemplary receiver in accordance with an exemplary embodiment of the inventions disclosed herein;

FIG. 3 is an illustration of an exemplary rendering of multiple pieces of user selected content on a display device in accordance with an exemplary embodiment of the inventions disclosed herein;

FIG. 4 is an illustration of another exemplary rendering of multiple pieces of user selected content on a display device in accordance with an exemplary embodiment of the inventions disclosed herein;

FIG. 5 is an illustration of another exemplary rendering of multiple pieces of user selected content on a display device in accordance with an exemplary embodiment of the inventions disclosed herein;

FIG. 6 is an illustration of another exemplary rendering of multiple pieces of user selected content on a display device in accordance with an exemplary embodiment of the inventions disclosed herein;

FIG. 7 is an illustration of another exemplary rendering of multiple pieces of user selected content on a display device in accordance with an exemplary embodiment of the inventions disclosed herein;

FIG. 8 is an illustration of another exemplary rendering of multiple pieces of user selected content on a display device in accordance with an exemplary embodiment of the inventions disclosed herein;

FIG. 9 is an illustration of another exemplary rendering of multiple pieces of user selected content on a display device in accordance with an exemplary embodiment of the inventions disclosed herein;

FIG. 10 is an illustration of another exemplary rendering of multiple pieces of user selected content on a display device in accordance with an exemplary embodiment of the inventions disclosed herein;

FIGS. 11a-11c is an illustration of an exemplary user interface for selecting a layout for rendering of multiple pieces of user selected content on a display device in accordance with an exemplary embodiment of the inventions disclosed herein; and

FIG. 12 is an illustration of an exemplary user interface for selecting when in time a particular rendering of multiple pieces of user selected content will be displayed on a display device in accordance with an exemplary embodiment of the inventions disclosed herein.

### DETAILED DESCRIPTION OF EXEMPLARY EMBODIMENTS

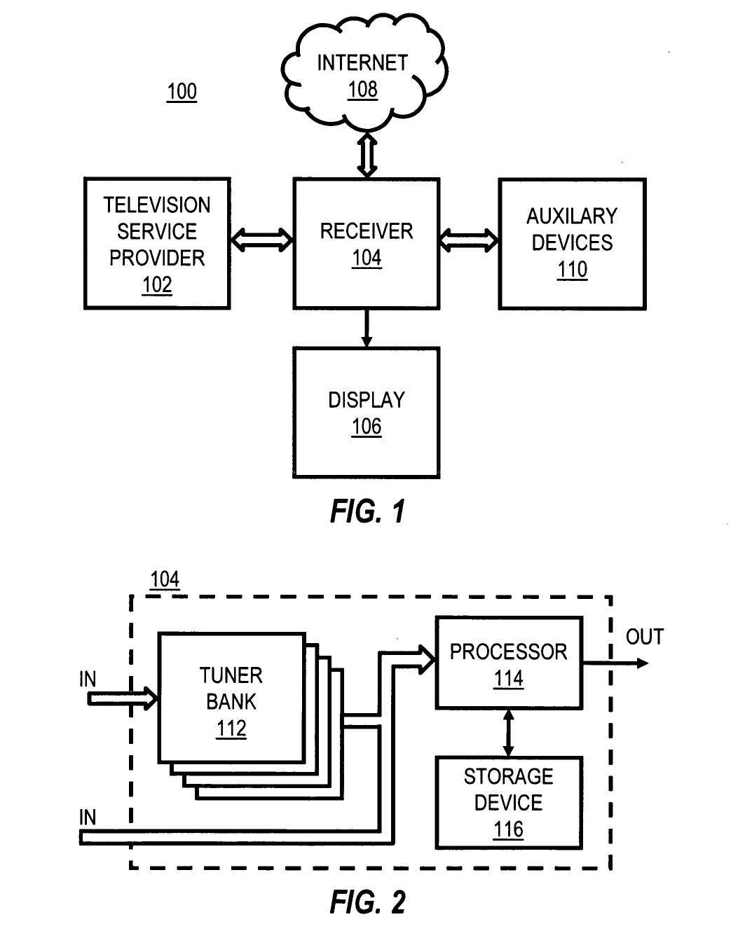

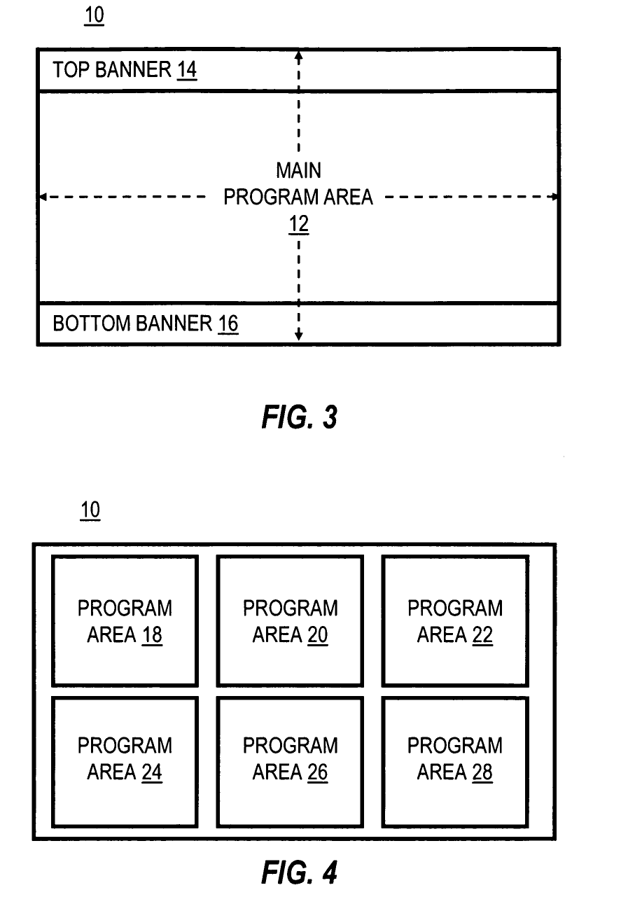

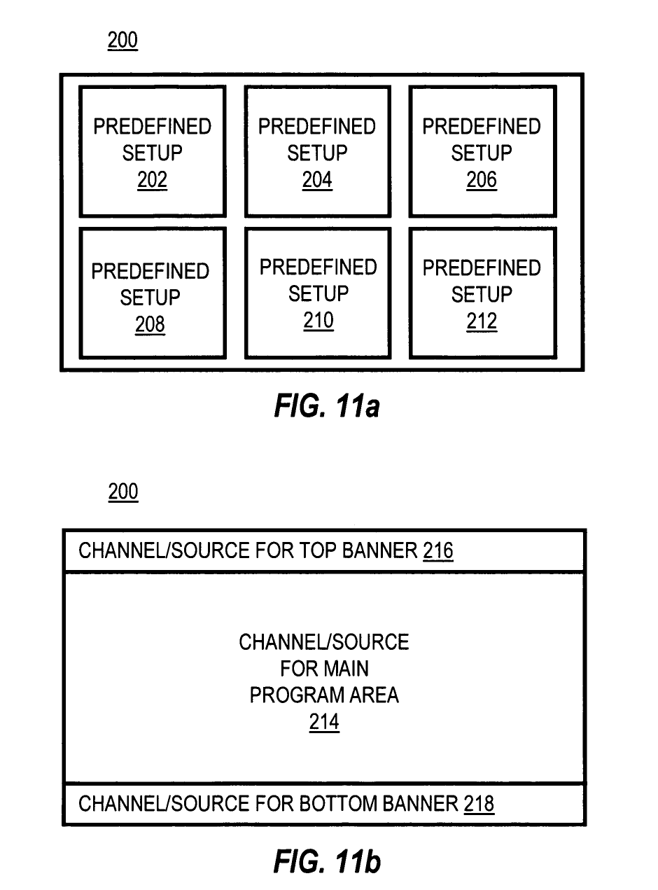

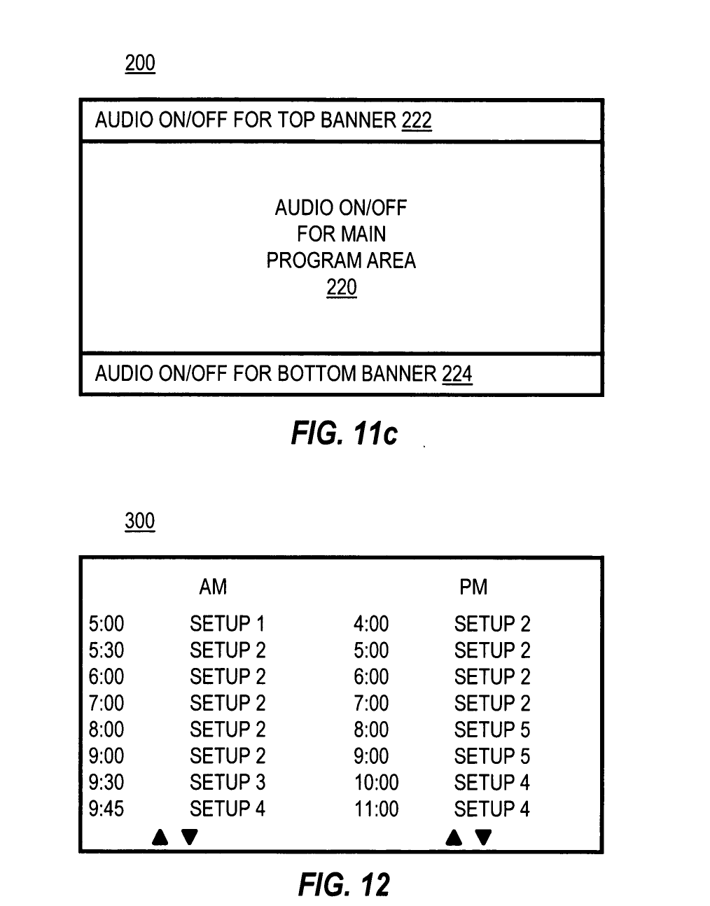

The present disclosure relates generally to systems, methods and apparatuses for rendering user customizable multimedia signals on a display device and more particularly to systems, methods and apparatuses for rendering multiple pieces of user selected content on a display device. FIGS. 1 and 2 and the accompanying description provide a general description of exemplary systems for distributing and receiving content which the user can select for rendering on the display device. FIGS. 3-10 and the accompanying description provide a general description of exemplary layouts that a user may create or select for rendering multiple pieces of user selected content on a display device. FIGS. 11a-11c and 12 and the accompanying description provide a general description of exemplary user interfaces for allowing a user to select multiple pieces of content to display on the display device.

FIG. 1 is a schematic representation of an exemplary system 100 in accordance with an exemplary embodiment of the inventions disclosed herein. The system 100 includes a receiver 104 that communicates with a television service provider 102 and may also communicate with the interne 108 and auxiliary devices 110. The system 100 also includes a display 106 that is communicates with the receiver 104. The television service provider 102 may be any type of provider (e.g., a cable television provider, a satellite television provider, etc.). The television service provider 102 may communicate with the receiver 104 via a wired connection (e.g., a fiber optic cable, a coaxial cable, etc.) or via a wireless connection (e.g., a satellite communications link, a cellular communications link, 802.11, WiFi, WiMax, or any typical wireless communications network, etc.). Additionally, the television service provider 102 may require that the owner of the receiver 104 pay for a subscription to the content provided by the television service provider 102. In general, the communication between the television service provider 102 and the receiver 104 may be any form of communication that would be understood by a person of ordinary skill in the art in view of the present disclosure. In addition to the television service provider 102, the receiver 104 may, in certain exemplary embodiments, communicate with auxiliary devices 110. The auxiliary devices 110 may include content sources such as, for example, DVD player, VHS tape players, audio receivers, etc. These devices may also communicate with the receiver in a manner that should be understood by a person of ordinary skill in the art in view of the present disclosure. The receiver 104 may also communicate with the internet 108 in certain exemplary embodiments. The internet 108 may provide content relevant to the television service provider 108 (e.g., programming schedules, etc.) or may provide additional content that can by rendered on the display 106. In general, various embodiments of the receiver 104 disclosed herein may communicate with any combination of the television service provider 102, the internet 108, the auxiliary devices 110, and any additional devices that may be appropriate for the receiver 104 to communicate with.

The display 106 may be any type of display for rendering content received by the receiver. In general the display 106 may be a television or a monitor or any other acceptable device (e.g., a mobile device or other computing device, etc.). In exemplary embodiments, various combinations of the display 106, the receiver 104, and the auxiliary devices 110 may be integrated into a single device. For example, in certain embodiments, the receiver 104 may be integrated into the display 106.

FIG. 2 is a schematic representation of an exemplary receiver 104 in accordance with an exemplary embodiment of the inventions disclosed herein. As shown, the receiver 104 includes a tuner bank 112, a processor 114 and a storage device 116. The tuner bank 112 may include one or more tuners (e.g., 1, 2, 3, 4, 5, 6, etc.). The tuner bank 112 may be configured to receive signals from the television service provider 102, the auxiliary devices 110 and/or the internet 108. Once the signals are received, one of the one or more tuners may be configured to select a particular channel of information (e.g., a television channel, or particular data from the internet). For example, the tuner may receive signals from the television service provider 102 and select a particular channel from the plurality of channels that are simultaneously received. In certain embodiments, each tuner may be configured to select a single channel and in other embodiments, the tuner may be configured to select a plurality of channels. In exemplary embodiments, whether the tuner bank 112 includes one or more than one tuner, the tuner bank 112 may be configured to select one or more channels and transmit the selected channels to the processor 114. In certain exemplary embodiments, the received signals may not need to be processed by a tuner bank 112. For example, information received from the interne 108 or the auxiliary devices 110 may not need to be tuned for a particular channel of information since multiple channels may not be simultaneously transmitted. Therefore, in exemplary embodiments, certain information that is received by the receiver 104 may bypass the tuner bank 112 and be sent to the processor 114 directly (or via some other part of the receiver 104).

The processor 114 is configured to receive the one or more channels of information from the tuner bank 112 or otherwise and aggregate the information as required. In particular, in exemplary embodiments, the processor may be configured to receive two or more channels of information and combine the two channels of information so that the information can be simultaneously displayed on a display device 106. For example, in certain embodiments, the processor 114 may be configured to receive two television channels and display both channels simultaneously. In other exemplary embodiments, the processor 114 may be configured to receive 3, 4, 5, 6, etc. channels of information and combine the information in a predetermined manner for display on the display device 106. Of course, the processor may receive any combination of channels from a television service provider 102, the internet 108, and/or auxiliary devices 110. Accordingly, in exemplary embodiments, the processor may receive a television channel and an internet data transmission (e.g., a web page, a video, an email, etc.) or a DVD movie and combine the channels of information for display on the display device 106. Alternatively, the processor may also be configured to receive a plurality of channels of information and combine the information such that various portions of the plurality of channels are transmitted to the display 106. In general, the processor is configured to receive the one or more channels of information and to process the information into a single channel of information (e.g., based on preselected or user selected preferences) that can be displayed on the display device 106. This single channel of information (i.e., the custom channel) may be available to the display device by for example, selecting a particular channel on a television, or by selecting a particular display setting for the receiver or any other method that may be understood by a person of ordinary skill in the art in view of the present disclosure. Additionally, in exemplary embodiments, the user selected settings may only need to be defined initially and then stored so that they can be referred to each time the custom channel is selected. In other exemplary embodiments, only a portion of the custom channel may be stored so that only a portion of the custom channel is predetermined.

The storage device 116 may be configured to store various types information. For example, the storage device 116 may store information related to how the processor is to combine the channels of information (e.g., user preferences, etc.) or which channels the tuner bank 112 is to select or what information is to be retrieved from the internet 108. Additionally, the storage device 116 may be configured to store received information so that it can be combined with other channels of information at a later time.

As would be understood by persons of ordinary skill in the art in view of the present disclosure, various aspects of the receiver 104 may be implemented in software, hardware, firmware, or any combination of these.

FIGS. 3-10 are illustrations of exemplary renderings of multiple pieces of user selected content on a display device in accordance with exemplary embodiments of the inventions disclosed herein. These exemplary embodiments illustrate various exemplary ways for organizing multiple pieces of user selected content (i.e., channels of information) for display (i.e., exemplary custom channels). These exemplary embodiments should not be considered limiting in anyway. In addition to the description of the various displays additional features may be included. For example, in embodiments the user may be provided with the ability to select audio associated with any of the plurality of channels. In exemplary embodiments, users may be able to change an individual channel of information without having to reconfigure the setup of the display. In exemplary embodiments, the user may be able select a particular channel of information and maximize it to occupy the display entirely (i.e., by itself). In exemplary embodiments, these features may be provided individually or in combination with one another and may or may not be accessible from a remote control device associated with one or more of the receiver 104 and/or display device 106.

FIG. 3 illustrates an example of one arrangement of user selected content. As illustrated in FIG. 3, the display 10 includes a main program area 12 that occupies the entire display 10. In addition, the display 10 includes a top banner 14 and a bottom banner 16 which occupy top and bottom portions of the display respectively. The embodiment of FIG. 3 illustrates that the banners 14 and 16 over lay on top of the main program area 12, but it should be understood that in exemplary embodiments, the three display areas may not overlap. For example, the main program area 12 may only occupy the area of the display 10 that is not occupied by the top banner 14 and the bottom banner 16. Additionally, in certain embodiments, the display may not include both a top and bottom banner 14 and 16 but may only include one banner (e.g., the top banner 14 or the bottom banner 16). Additionally, in certain embodiments, the banner may be on either side of the display device. The exemplary embodiment of FIG. 3 may be of particular interest if a user is interested in watching a particular channel but is also interested in simultaneously obtaining information from a different channel. For example, in an exemplary embodiment, the main program area 12 may be configured to display a movie or a particular television program (e.g., the program on ABC). However, there may also be information about some other event (e.g., a sporting event or a news story) that the user is interested in obtaining information about. The user may not want to watch the sporting event or news story, but may simply be interested in the scores or the headline news. Therefore, in an exemplary embodiment, the top banner may include sports scores from for example, ESPN and the bottom banner may, for example, include the headline news from CNN (or stock prices from CNBC, etc.). As would be readily understood by a person of ordinary skill in the art, CNN for example, continually includes headline news at the bottom of their television broadcast. Using the processor described above, in embodiments, the processor may receive the CNN broadcast and crop (or otherwise appropriately process) the broadcast to include only the headline news information. That banner of information may then be combined with the main program selected for the main program area 12 (e.g., within the top banner 14 or the bottom banner 16). Similarly, other television channels include similar information (ESPN includes updates sports scores in their broadcast and CNBC includes current stock process in their broadcast). Accordingly, users would not be required to continually switch channels to view information from each of these channels but could obtain the relevant information simultaneously on a single display.

In addition, although the above embodiment illustrates three television channels, in exemplary embodiments, one or more of the areas 12, 14, and 16 may include information from other sources as well. For example, a DVD movie from an auxiliary device 110 may be displayed in the main program area 12 and the information in either of the top or bottom banners 14 and 16 may be received via the internet 108. This may provide the user with additional options to configure their display. For example, in exemplary embodiments, content providers may make multiple banners of information available to users via television channels or via the internet and users may be able to select one or more of the banners of information to combine with an other channel (e.g., when the user is configuring the display device as discussed in more detail elsewhere herein). Accordingly, in an exemplary embodiment, CNN.com may make a variety of banners available to user such as for example (a U.S. news banner, an international news banner, a financial news banner, etc.) and ESPN.com may provide a similar service by for example allows users to select from football scores, basketball scores, baseball scores, college scores, professional scores, etc.

FIG. 4 illustrates an example of another arrangement of user selected content. As seen in FIG. 4, the display may also be configured to include a plurality (e.g., 2, 3, 4, 5, 6, 7, 8, 9, 10, etc) of channels of information in each of program areas 18, 20, 22, 24, 26, and 28. Although FIG. 4 shows 6 channels of information, any number of a plurality of channels could be configured. In addition, although not illustrated in FIG. 4, the display 10 may also include a banner of information like the banners discussed above. This configuration of a display may be particularly useful if for example, the user was interested in viewing similar events simultaneously, for example, several ongoing football games. One benefit of this approach is that the various games can be selected by the user. Additionally, if combined with for example, prerecorded information (e.g., a DVR), the user may be able to watch multiple programs simultaneously even though they were originally aired at different times. Although, the sound in FIG. 3, may be associated with the main display area 12 (or one of the banners if the user preferred such an arrangement). In the exemplary embodiment of FIG. 4, it may be desirable to provide the user with a convenient means for continually switching from one program to another. This embodiment may also be of interest in commercial settings since the displays 10 may be much larger. Currently, these locations use multiple independent television display systems but with the processor described above, the multiple displays could be replaced with a single display and a single receiver.

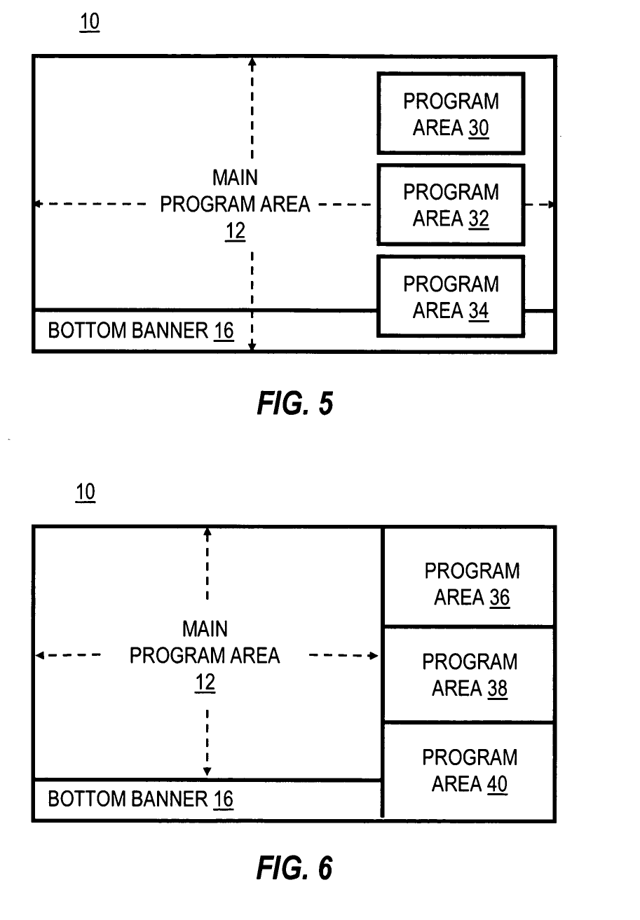

FIG. 5 illustrates an example of another arrangement of user selected content. As illustrated in FIG. 5, the main program area 12 once again occupies the entire display 10. Additionally, there is a bottom banner 16 which may be similar to the banners described in FIG. 3. Although not shown, the display 10 may also include a top banner like the one described with respect to FIG. 3. Also included on the display 10 are program areas 30, 32, and 34. Although FIG. 5 shows three such program areas, it should be readily understood that any number of such areas may be included on the display 10 (e.g., 0, 1, 2, 3, 4, 5, 6, etc.) and they do need to be arranged on a single side of the display 10 as shown in FIG. 5. The program areas may include information from any source as described above. In addition, with multiple smaller program areas, like the ones illustrated in FIG. 5, the program areas may be configured to appear only when desired. In particular, in exemplary embodiments, main program area 12 may include a desired television broadcast program and the bottom manner may include for example sports scores. Program area 30 may include a word processing document that the user desires to edit while watching the program on main program area 12. Program area 32 may not be present always and may only appear when the user receives a new email message so that the user can review and respond to the message if desired. Program area 34 may display a website selected by the user which includes information related to the document that the user is working on in program are 30 and the user may be permitted to “minimize” this program window when desired. Accordingly, in certain embodiments, the user selected content can be dynamically arranged so that the user can choose to move, minimize, or even close certain program areas as desired.

FIG. 6 illustrates an example of another arrangement of user selected content. FIG. 6 is similar to the embodiment of FIG. 5 except the main program area 12 does not occupy the entire display 10. This may be preferable in certain embodiments if the user does not want the various program areas to overlap. Additionally, as seen in FIG. 6, the bottom banner 16 only occupies a bottom portion of the main program area 12. In this manner, it is possible to display content in a subpart of a display area and not just in a subpart of the display 10. In exemplary, embodiment, it may be desirable to display the content seamlessly as shown in FIG. 6 and in other embodiments, it may be desirable to include a space between each of the pieces of content. As should be readily understood, the program areas 36, 38, and 40 may be configured in a manner that this similar to the program areas described throughout the specification (e.g., with respect to FIG. 5).

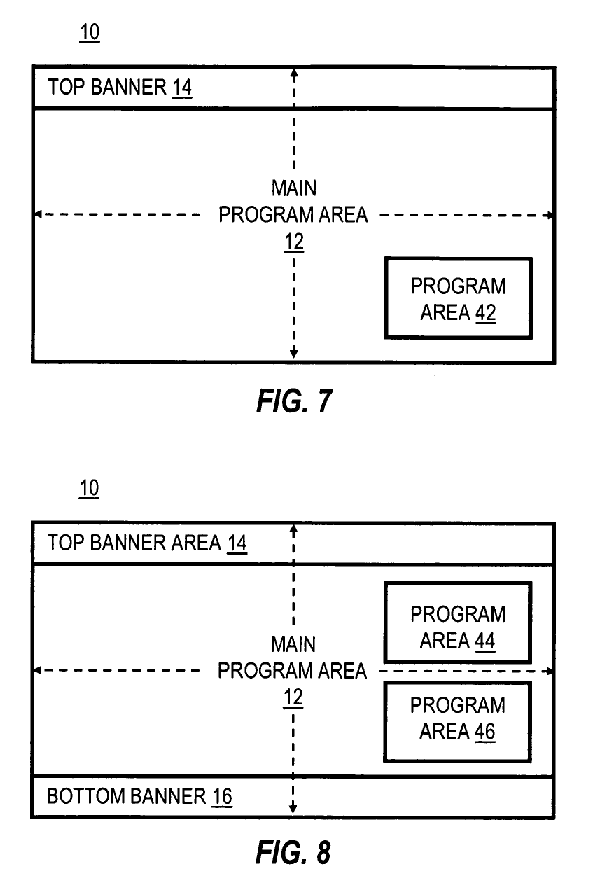

FIG. 7 illustrates an example of another arrangement of user selected content. FIG. 7 is similar to the embodiment of FIG. 5 described in more detail above and includes a main program area 12, a top banner 14 and a program area 42. Each of these program areas may include features similar to the features of the program areas described throughout this disclosure. In particular, the program area 42 may be configured in a manner that this similar to the program areas described throughout the specification (e.g., with respect to FIG. 5).

FIG. 8 illustrates an example of another arrangement of user selected content. FIG. 8 is similar to previously described embodiments and includes a main program area 12 that occupies the entire display 10, a top banner 14, a bottom banner 16, and program areas 44 and 46. Each of these program areas may include features similar to the features of the program areas described throughout this disclosure. In particular, the program areas 44 and 46 may be configured in a manner that this similar to the program areas described throughout the specification (e.g., with respect to FIG. 5).

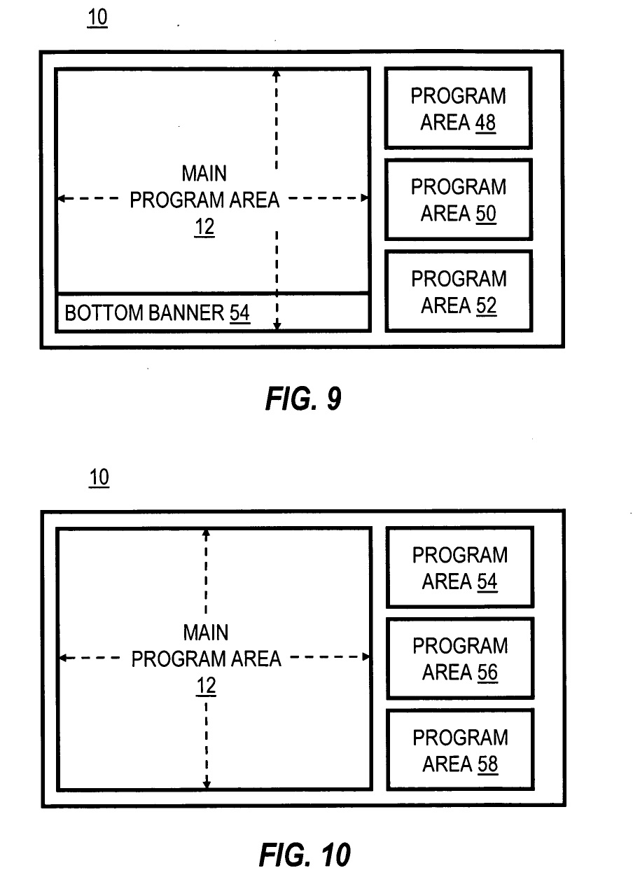

FIGS. 9 and 10 illustrate examples of other arrangements of user selected content. FIGS. 9 and 10 are similar to the embodiment of FIG. 6 but include blank space between the various program areas. The display 10 in FIG. 9 includes a main program area 12 (at occupies a portion of display 10), a bottom banner 54 (that occupies a portion of the main program area 12), and three program areas 48, 50, and 52. The use of blank space in exemplary embodiments may be desirable in some instances. For example, such a use of blank space may allow non overlapping content to be displayed on the device simultaneously without distorting the content (e.g., changing the aspect ratios or cropping the content). FIG. 10 is similar to FIG. 9 except the main program area 12 does not include a banner. Each of these program areas in these figures may include features similar to the features of the program areas described throughout this disclosure.

As discussed throughout the present specification, exemplary embodiments of the inventions disclosed herein include the ability to display multiple pieces of user selected content. Accordingly, in exemplary embodiments, a user interface for allowing the user to select and configure a particular channel may be provided. The user interface may be configured in any manner that allows a user to select one of a predetermined number of display setups or for allowing the user to create an individually configured display. Additionally, the interface may be configured to allow the user to select the various channels of information that are to be displayed in the various portions of the display device and to select which of the plurality of channels to include audio information for. The interface may be based on the internet or on the television. In exemplary embodiments, the internet interface may be more flexible for allowing a user to customize more features. Additionally, the internet interface may be configured to communicate with the interface, especially in embodiments where the receiver 104 is connected to the internet 108. It should be understood, however, that such a connection is not required as there may be other methods for linking the internet based interface with the receiver so that the receiver has knowledge of the user selected parameters.

FIGS. 11a-11c is an illustration of an exemplary user interface for selecting a layout for rendering of multiple pieces of user selected content on a display device in accordance with an exemplary embodiment of the inventions disclosed herein. In exemplary embodiments, the interface in FIGS. 11a-11c may be implemented from the receiver. FIG. 11a shows a user interface for selecting one of a plurality of predefined setups 202-212. Although there are six predefined setups 202-212 in FIG. 11a, it should be readily understood that any number of predefined displays may be provided for user selection (e.g., 1, 2, 3, 4, 5, 6, 7, 8, 9, 10, etc.). Additionally, if there is only one such predefined setup, this portion of the interface may not be provided in certain exemplary embodiments. Using an input device (e.g., a remote control), the user may select one of the predefined setups 202-212. Once the user selects one of the predefined setups, the selected setup may be graphically displayed to the user as shown in FIG. 11b. As FIG. 11b illustrates, the user may select for example, the same predefined setup shown in FIG. 3 which includes a main program area, a top banner and a bottom banner. The interface may, in certain embodiments, provide the selected predefined setup as a graphical interface and allow the user to select the channel or source for each defined area. For example, as illustrated in FIG. 11b, the user may be prompted to input a channel/source for the main program area 214, for the top banner 216, and for the bottom banner 218. Once the user has selected the channel/source for each area of the display, FIG. 11c illustrates that the user may then be prompted to select with of the areas is to provide audio for the user. For example, as illustrated, the user may be prompted to select whether the audio is on or off for the main program area 220, for the tope banner 222, and for the bottom banner 224. In exemplary embodiments, the user may only be required to select audio for one area since it may not be desirable to allow audio output for more than one channel/source simultaneously unless the audio was being separated for a particular purpose. Of course, the interface described above is merely exemplary and any suitable interface may be utilized is various embodiments. For example, the interface may not be graphical or the interface may allow the user to resize various areas of the display.

In certain exemplary embodiments, the display device may be configured to select a different plurality of channels of information based on a particular time. This feature may, in exemplary embodiments, be used in conjunction with guide devices that are provided by may television service provides 102 or with for example, the TiVo guide service. For example, in exemplary embodiments, the user may configure multiple custom channels so that each of the custom channels has a particular value to the user at a particular time or because of a certain event. For example, the user may have a particular custom channel during the morning hours and a different custom channel in the evening. Alternatively, the user may have a particular custom channel for all times except if a certain program is currently running (e.g., the user's favorite sporting event is on). These features can be provided independent of a guide feature or in conjunction with such a feature by selecting to associate particular display settings with particular programs or guides. Additionally, with the use of DVRs, it may be possible to configure custom channels using prerecorded channel information.

FIG. 12 is an illustration of an exemplary user interface for selecting when in time a particular rendering of multiple pieces of user selected content will be displayed on a display device in accordance with an exemplary embodiment of the inventions disclosed herein. As seen in FIG. 12, after the user has setup multiple predefined setups (e.g., setups 1-5), the user may select a particular predefined setup for particular times. In certain embodiments, the times may be customized and in other embodiments, the times may be predefined within the interface. Additionally, as discussed above, the predefined setups may also be selected based on a particular event such a particular day of the week or a particular program. Allowing a user to define a plurality of predefined setups and then decide which predefined setup to display based on other factors (e.g., time, etc.) may be particularly useful since it would permit the user to merely turn on the display device and tune to the custom channel to view the preferred setup. That is, the user would not have to select one of many predefined setups each time the user wanted to use the display device.

In certain embodiments, the custom channel may be the default channel that is displayed with the display device is powered on and in other exemplary embodiments; the user may have to select the custom channel after powering on the display device. Additionally, the inventions described herein may be utilized on mobile devices as well as non-mobile devices (e.g., televisions, projector systems, etc.).

The embodiments described herein are intended to be illustrative of this invention. As will be recognized by those of ordinary skill in the art, various modifications and changes can be made to these embodiments and such variations and modifications would remain within the spirit and scope of the invention defined in the appended claims and their equivalents. Additional advantages and modifications will readily occur to those of ordinary skill in the art. Therefore, the invention in its broader aspects is not limited to the specific details and exemplary embodiments shown and described herein.

What is claimed is:

1. A receiver comprising:
a tuner for receiving a first piece of content; and
a processor configured to receive the first piece of content from the tuner and a second piece of content, combine the first piece of content with a portion of the second piece of content to create a combined piece of content, and output the combined piece of content to a display device.

2. The receiver of claim 1, wherein the first and second piece of content are selected by a user.

3. The receiver of claim 1, wherein at least one of the first piece of content and the second piece of content is received from a television service provider.

4. The receiver of claim 1, wherein the first piece of content and the second piece of content are both received from a television service provider.

5. The receiver of claim 4, wherein the combined piece of content includes less than the entirety of the second piece of content.

6. The receiver of claim 1, wherein at least one of the first piece of content and the second piece of content is received from the internet.

7. The receiver of claim 1, further comprising a storage device for storing user selected parameters for combining the first piece of content with the portion of the second piece of content to create the combined piece of content.

8. The receiver of claim 1, further comprising a storage device for storing at least one of the first piece of content and the second piece of content.

9. The receiver of claim 8, wherein the first piece of content is stored in the storage device to time shift the content and combined with the second piece of content which is not time shifted.

10. The receiver of claim 1, wherein a plurality of combined pieces of content can be defined and one of the plurality of combined pieces of content is displayed based on a determination of a particular event.

11. The receiver of claim 1, wherein the first piece of content and the second piece of content are combined such that the first piece of content is substantially unaltered and at least a portion of the second piece of content is displayed over the first piece of content.

12. The receiver of claim 11, wherein the at least a portion of the second piece of content is configured to be displayed as a banner over the first piece of content.

13. The receiver of claim 1, wherein the receiver is configured to allow the user to select audio associated with any of the first piece of content and the second piece of content.

14. The receiver of claim 1, wherein the receiver is configured to allow the user to change a selected first piece of content and the second piece of content without having to reconfigure the receiver.

15. The receiver of claim 1, wherein the receiver is configured to allow the user to select one of the first piece of content and the second piece of content and maximize it to occupy the display.

16. A method for creating a customized piece of content, the method comprising:
receiving a first piece of content and a second piece of content,
combining the first piece of content with a portion of the second piece of content to create a combined piece of content; and
outputting the combined piece of content to a display device.

17. The method of claim 16, wherein the first and second piece of content are selected by a user.

18. The method of claim 16, wherein at least one of the first piece of content and the second piece of content is received from a television service provider.

19. The method of claim 16, wherein the first piece of content and the second piece of content are both received from a television service provider.

20. The method of claim 19, wherein the combined piece of content includes less than the entirety of the second piece of content.

21. The method of claim 16, wherein at least one of the first piece of content and the second piece of content is received from the internet.

22. The method of claim 16, further comprising storing user selected parameters for combining the first piece of content with the portion of the second piece of content to create the combined piece of content.

23. The method of claim 16, further comprising storing at least one of the first piece of content and the second piece of content.

24. The method of claim 23, wherein the first piece of content is stored to time shift the content and combined with the second piece of content which is not time shifted.

25. The method of claim 16, wherein a plurality of combined pieces of content can be defined and one of the plurality of combined pieces of content is displayed based on a determination of a particular event.

26. The method of claim 16, wherein the first piece of content and the second piece of content are combined such that the first piece of content is substantially unaltered and at least a portion of the second piece of content is displayed over the first piece of content.

27. The method of claim 26, wherein the at least a portion of the second piece of content is configured to be displayed as a banner over the first piece of content.

28. The method of claim 16, further comprising allowing the user to select audio associated with any of the first piece of content and the second piece of content.

29. The method of claim 16, further comprising allowing the user to change a selected first piece of content and the second piece of content without having to reconfigure the receiver.

30. The method of claim 16, further comprising allowing the user to select one of the first piece of content and the second piece of content and maximize it to occupy the display.

31. A system comprising:
a computer readable storage medium for storing therein a plurality of pieces of content; and
a processor associated with the computer readable medium for receiving a request for one of the plurality of pieces of content and for transmitting the selected content to a receiver associated with a display system;
wherein each of the plurality of pieces of content are configured to be combined as a banner with a piece of content from a television service provider for display on a display device.
